(19) United States
(12) Patent Application Publication
(10) Pub. No.: US 2006/0139173 A1
(43) Pub. Date: Jun. 29, 2006

(54) Anti-counterfeiting apparatus capable of remote identifying

(76) Inventors: Chien-Hsing Fang, Hsinchu City (TW); Leeway Yen, Qionglin Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/082,657

(22) Filed: Mar. 18, 2005

(30) Foreign Application Priority Data
Dec. 15, 2004 (TW) 093139016

(51) Int. Cl. G08B 13/14; G06K 19/06

(52) U.S. Cl. 340/572.7; 340/572.3; 235/492

(57) ABSTRACT

An anti-counterfeiting apparatus capable of remote identifying is provided. It mainly sets a membrane on an outer package of a product, and an identifying module capable of remote identifying is set on the membrane such that in a process of transmitting, transporting, and managing the product, an outer apparatus is used to read stored product data by the identifying module thereby easier controlling the product. Further, when using and sealing off the product, the identifying module can be destructed or removed at the same time to remove its identifying ability. Although the outer package of the product is refilled fake or counterfeited product to be sold, since the membrane or the identifying cannot be read again, normal product transaction cannot be done thereby easily distinguishing real or counterfeited products.

### FIELD OF THE INVENTION

The present invention is related to an anti-counterfeiting apparatus, and more particularly to an anti-counterfeiting apparatus capable of remote identifying for not only distinguishing real or counterfeited products, but also quickly identifying products and easily managing.

### BACKGROUND

Accordingly, in a process of controlling the transmission of products, identifying and anti-counterfeiting products is always what various makers paid a lot of attention to. A prior art method of controlling products, such as identifying barcodes, has much benefit to identifying and controlling products. Coordinate with applying computer databases and identifying barcodes, an ability of warehousing managing and dynamically tracing a large amount of products can be comparatively raised.

However, technology progress and society advance makes the prior art product controlling technology not meet the application of industries nowadays; for example, since the product categories extremely increased, such that the coding numbers of barcodes are not enough. Besides, the identifying barcodes needs to pass through the optical scan equipments and an optical scan path with obstacles to proceed short-distance scanning to become useful data to be used. It is not convenient in use and cannot be suitable in managing the access of the big amount of products.

In connection with the previous mentioned problems of controlling products, another product data reading and controlling technology is developed. As shown in FIG. 1, a wireless label capable of exchange product data through a radio frequency technology is pasted or bonded on an outer package or bottle 105 of a product 10 to be protected from counterfeiting. The wireless label 11 comprises a chip 111 capable of storing product data and gives an independent distribution code (not shown) of each product to store in the chip 11. The chip 11 further connects to at least one antenna 115 of benefit to transfer signals. Therefore, by an outer reading apparatus (not shown), under a situation of without setting a scanning path without obstacles, a wireless radio frequency technology is used to read product data stored in the chip 111 to achieve an object of quickly identifying product categories and anti-counterfeiting.

Although such a wireless label 11 can achieve an object of controlling products, however, the wireless label 11 is directly set on the outer package 105 of the product 10 in this way. Thus, after the consumer bought or used the product 10, the wireless label 11 was not disabled immediately such that the product data stored in the wireless label 11 still can be read by an outer apparatus and cannot avoid from minded people using dishonest means to ascertain the product category bought or owned by the consumer. It not only hurts the privacy of the consumer but also has potential danger on the safety of the consumer.

Further, after using the product, if the wireless label 11 of the product 10 was not destructed, it still has an ability of being read or identified such that unworthy people has an opportunity to repack the product outer package or bottle 105 after using but with good apparent. They can collect, refill with counterfeited objects, and sale the counterfeited products in market as an apology by the way of passing off fish eyes for pearls. Not only the consumer will be deceived to buy counterfeited product, even the safety of the consumer will be damaged, but also the reputation of the makers of original real products 10 is destructed. It is the reason why expensive liquor, cosmetics, accessories, or pharmaceuticals are easy to be counterfeited.

### SUMMARY OF THE INVENTION

Accordingly, how to design an anti-counterfeiting apparatus in connection with previous mentioned shortcomings of the prior art technology, and more particularly an anti-counterfeiting apparatus capable of remote identifying which not only can distinguish real or counterfeiting of products but also has an effect of quickly identifying product and conveniently managing is an inventive point of the present invention. Therefore,

It is a primary object of the present invention to provide an anti-counterfeiting apparatus capable of remote identifying. It mainly fixes a wireless label at a seal of a product such that after the product is used and unsealed, the wireless label can be directly destructed or removed at the same time in order to let it lose an ability of being read or identified the product data and cannot be reused improperly to be a counterfeited product. This way, an object of anti-counterfeiting products can be achieved.

It is a secondary object of the present invention to provide an anti-counterfeiting apparatus capable of remote identifying which uses the radio frequency technology of its wireless label to not only examine data of the products remote and quickly to easy manage the products, but also identify real or counterfeited products quickly to protect the reputation of the makers of the real products and the safety of the consumers.

It is another object of the present invention to provide an anti-counterfeiting apparatus capable of remote identifying which removes the ability of being read or identified improperly of the products with an easy way after the users buy the products. It not only is benefit to maintain the personal privacy but also helps to maintain their safety.

To achieve the previous mentioned objects, a structure of a preferred embodiment of the present invention mainly comprises: a membrane, an identifying module set therein, and capable of being fixed on a product; and a destructive structure fixed on part of a surface of the membrane for naturally destructing the identifying module when the destructive structure is open.

### BRIEF DESCRIPTION OF DRAWINGS

FIG. 1 is a structural diagram of a prior art product identifying apparatus.

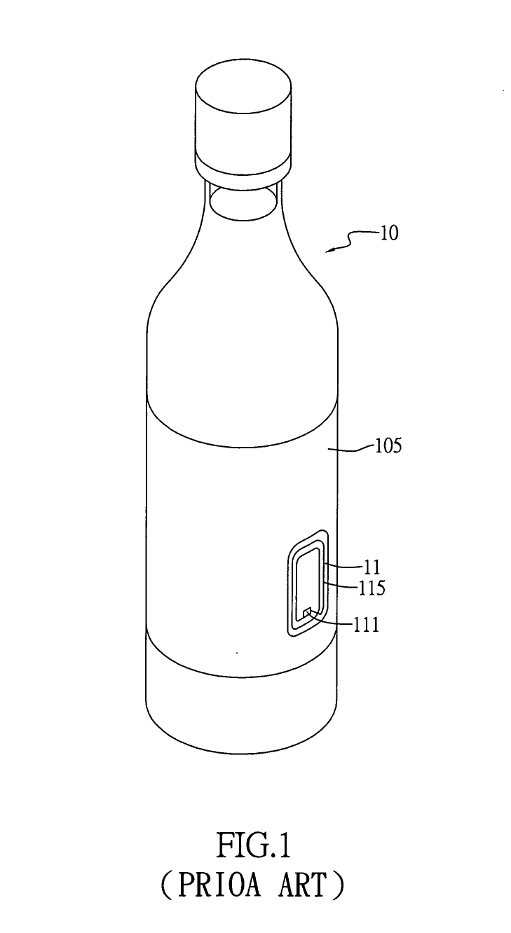

FIG. 2A is a structural top view of a preferred embodiment of an anti-counterfeiting apparatus of the present invention.

FIG. 2B is a using diagram of the preferred embodiment of the present invention shown in FIG. 2A when in use.

FIG. 3A is a structural diagram of another preferred embodiment of an anti-counterfeiting apparatus of the present invention.

FIG. 3B is a using diagram of the preferred embodiment of the present invention shown in FIG. 3A when in use.

FIG. 4 is a structural diagram of yet another preferred embodiment of an anti-counterfeiting apparatus of the present invention.

Fig. 5A is a structural diagram of yet another preferred embodiment of an anti-counterfeiting apparatus of the present invention.

FIG. 5B is a using diagram of the preferred embodiment of the present invention shown in FIG. 5A when in use.

FIG. 6 is a structural diagram of yet another preferred embodiment of the present invention.

### DETAILED DESCRIPTION

The structural features and the effects to be achieved may further be understood and appreciated by reference to the presently preferred embodiments together with the detailed description.

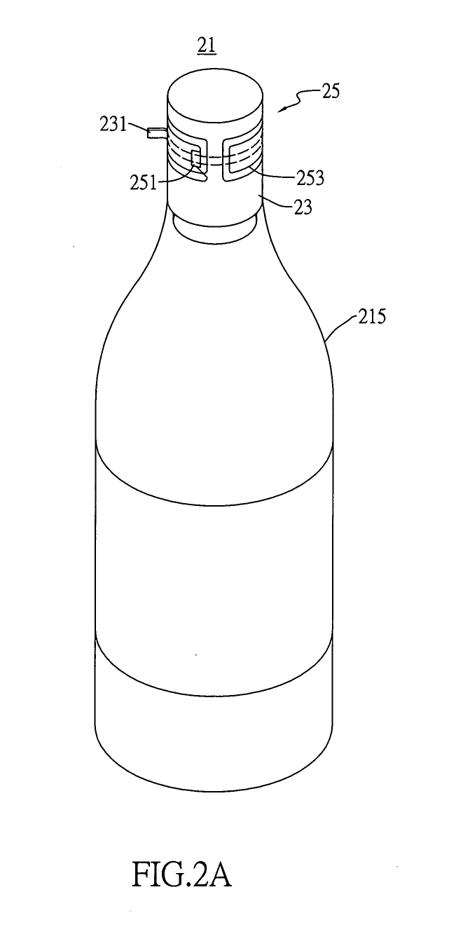

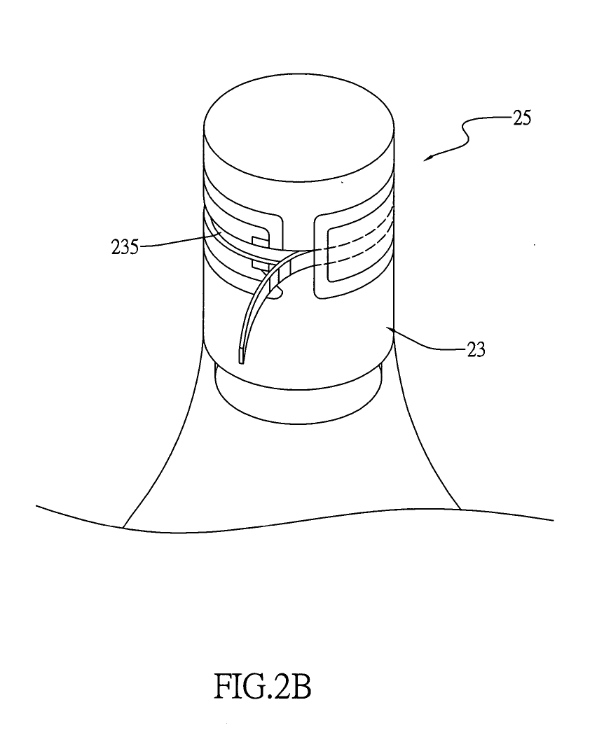

First, referring to FIG. 2A to 2B, respectively a structural diagram and a use state diagram of a preferred embodiment of the present invention. As shown, the anti-counterfeiting apparatus capable of remote identifying mainly fixes a membrane 23 on a package 215 of a product 21 (such as a bottle or gallipot, etc.). The package 215 can use a seal (not shown) to close the opening and cover the seal and part of the outer surface of the package 21 by the membrane 23 wherein the membrane 23 comprises an identifying module 25 and a destructive structure 231.

The identifying module 25 comprises an identifying chip 251 and an antenna 253. The identifying chip 251 can be electrically connected to the antenna 253. Therefore, the identifying chip 251 can receive or transmit a radio frequency signal by the antenna 253. The identifying chip 251 can store bigger amount of data than the prior art identifying barcodes, and thus an independent product digital number can be pre-given to each product 21 and stored in the identifying chip 251. An outer apparatus (not shown) can use suitable radio frequency signals to sense the antenna 253 such that the outer apparatus can remote read the product number stored in the identifying chip 251. Thereby, no matter in either one of the situations of warehouse, transporting distribution, or transaction vend, the product data stored in the identifying chip 251 quickly and accurately without an optical scanning path or short-distance scanning path such that each product can proceed quickly in a distribution or transaction process.

Further, when the user wants to use the object filled in the product 21 and the package, an unsealing process is needed first. In the unsealing process, the membrane 23 wrapping the opening and the seal is removed first, meanwhile, the destructive structure 231 is used to produce a crack 235 on the membrane 23. At the same time, the identifying module 25 attached on the membrane 23 is destructed to make the identifying module 25 lose the original ability of being read or identified such that the identifying module 25 cannot read the product data stored therein through an outer apparatus again to achieve an capability of anti-counterfeiting.

For example, in the embodiment, by opening the destructive structure 231 or producing the crack 235, the identifying chip 251 on the identifying module 25 is directly destructed, the antenna 253 and the identifying chip 251 are disengaged, or the antenna 253 forms an abruption and radio frequency signals cannot be transmitted again. Thereby, the object of destructing the identifying module 25 and making it unable to be used again is achieved.

This way, it not only prevents from minded people knowing the object data bought by the consumers through an outer apparatus and therefore knowing the privacy of life mode or product category owned by the consumers, but also prevents from dishonest industrialists collecting these exhausted product package 21, refilling them to be counterfeit products, and selling them. The object of anti-counterfeiting products and protecting personal privacy can be further achieved.

Of course, in another embodiment of the present invention, the membrane 23 can be the surface of the package 215, and the antenna 253 and the identifying chip 25 are directly fixed to the package 215, or the product seal, the surface, the outer package, or the outer package surface. The object of the present invention can also be achieved.

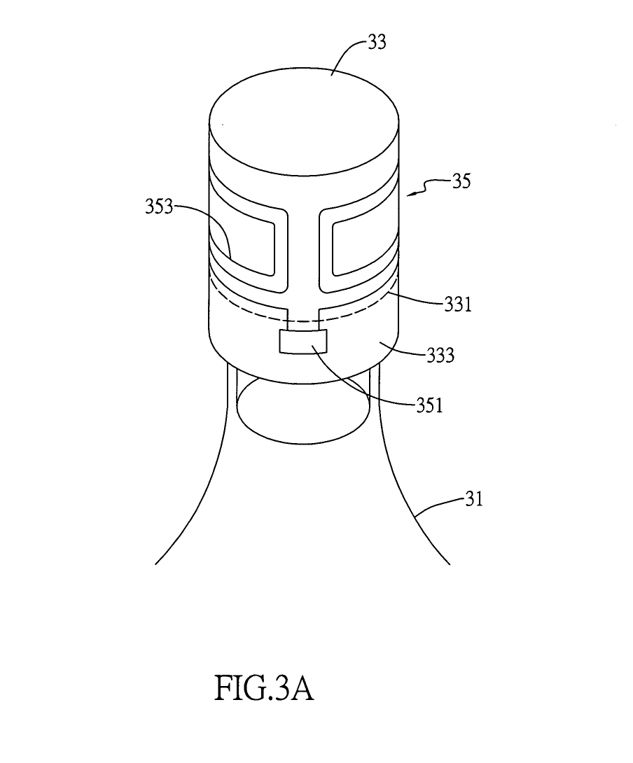

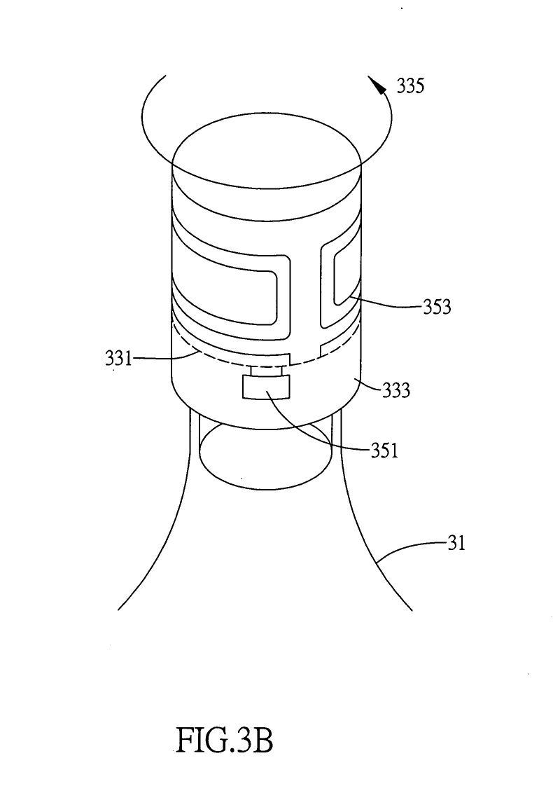

Further, referring FIGS. 3A and 3B, are a structural diagram and use state diagram of each aspects of another embodiment of the present invention. As shown, in the embodiment, the anti-counterfeiting apparatus capable of remote identifying of the present invention can apply on a screw-topped package 31. It mainly fixes an identifying module 35 on a screw-top 33 wherein the screw-top 33 is formed by connecting a partially broken groove 331 and an anti-counterfeiting ring 333. The identifying chip 351 and the antenna 353 on the identifying module 35 can be fixed on the screw-top 33 and the anti-counterfeiting ring 333 respectively. When the user wants to use the product sealed in the package 31 by the screw-top 33, the screw-top 33 is needed to be opened first. Now, since the partially broken groove 331 existed between the screw-top 33 and the anti-counterfeiting ring 333 such that the connecting force between the screw-top 33 and the anti-counterfeiting ring 333 is not enough to resist the rotating force 335 of the screw-top 33 and thus it totally broken and disengaged. At the same time as disengaging, the identifying chip 351 and the antenna 353 positioned at two places are disengaged too and further the identifying module 35 is destructed. This way, the identifying module 35 loses the ability of being read or identified by the outer apparatus again to achieve the object of anti-counterfeiting products. The predicted result of the previous embodiment can also be achieved.

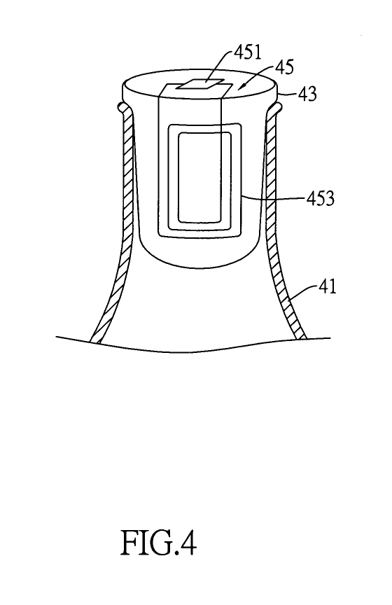

Furthermore, referring FIG. 4, a use state diagram of another embodiment of the present invention. As shown, in the embodiment, the identifying module 45 is set in a cap 43 made of a material of cork or plastic, and the cap 43 is used on an outer package 41 capable of filling liquid, such as bottles, wherein the identifying chip 451 and the antenna 453 comprised in the identifying module 45 can be selectively set both in the cap 43 or set one of them in the cap 43. When the user wants to use the liquid in the bottle 41, the cap 43 is taken out through a corkscrewing process. In this process of taking out the cap, a corkscrew (not shown) is used to rotate into the cap 43 until a prior depth to take out the cap 43 from the bottle 41. In the corkscrewing process of the corkscrew rotating into the cap 43, the antenna 453 or the identifying chip 451 comprised in the identifying module 45 is destructed. Therefore, after corkscrewing, the ability of being read or identified of the identifying module 45 is lost by destructing the identifying module 45, and the object of anti-counterfeiting of the previous mentioned embodiment is further achieved.

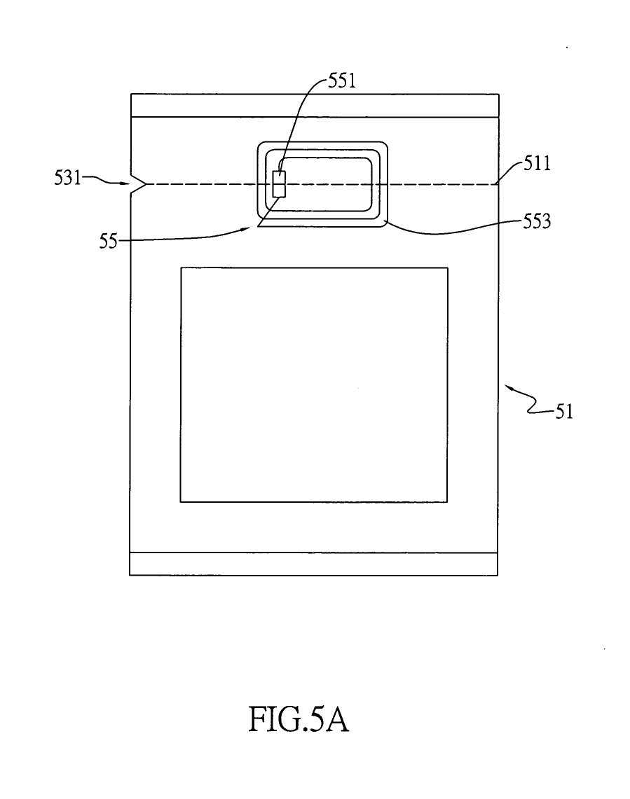

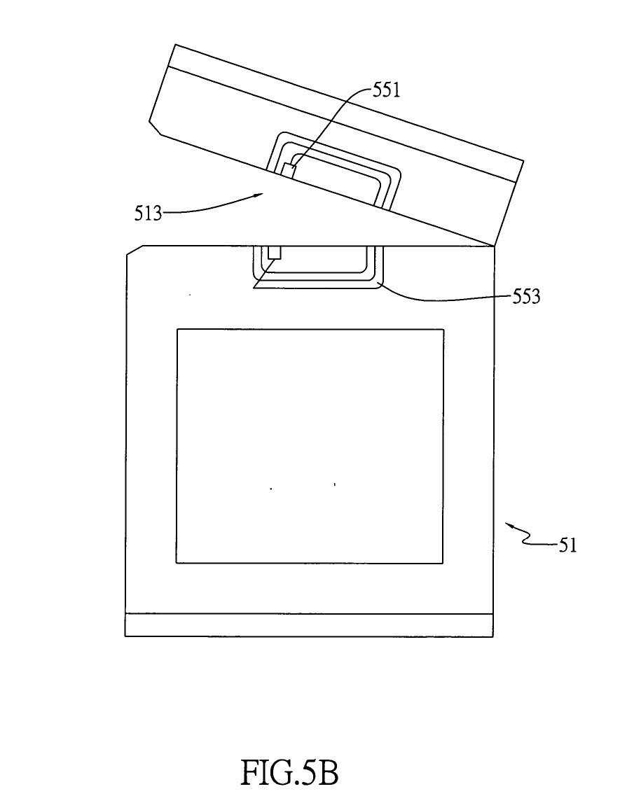

Continuously, referring FIGS. 5A and 5B, a stereoscopic diagram and use state diagram of another embodiment of the present invention. As shown, in the embodiment, the anti-counterfeiting apparatus capable of remote identifying can be applied on an outer package, outer packing box, or soft package 51 capable of storing products. The identifying module 55 is fixed on a proper position of a seal 511 on the soft package 51. When the consumer wants to open the seal 511 to take out the product therein, a proper force is needed to be apply at the seal 511 or a destructive groove 531 of the soft package 51 and make it bigger such that an opening 513 is produced on the package 51 for consumers to easy to take the products out and use. By extending the destructive groove 531 and augmenting the opening 513, the identifying module 55 is also destructed, such as disengaging the antenna 553 and the identifying chip 551 or directly destructing the identifying chip 551. This way, the identifying module 55 will lose the identifying ability of transferring the product data with the outer apparatus through the radio frequency technology. The object of anti-counterfeiting products can be achieved, and expected result of the previous embodiment can also be achieved.

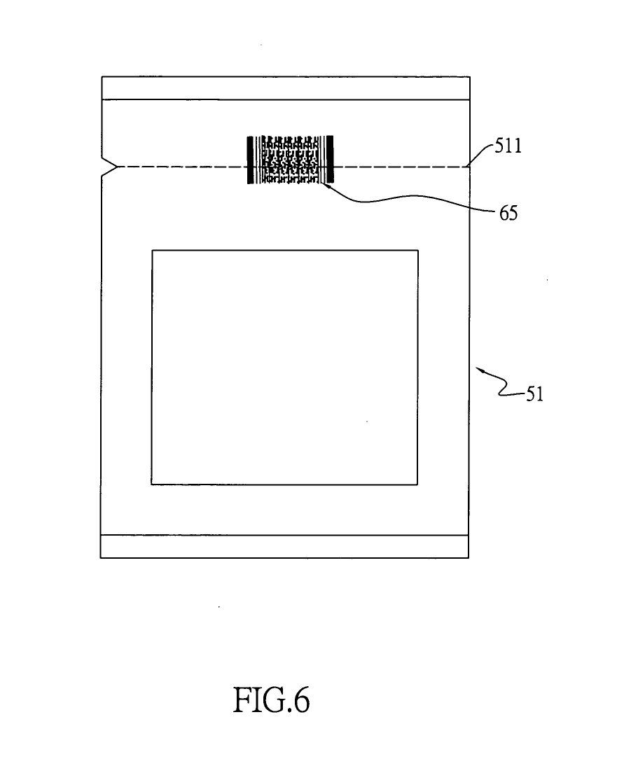

Finally, referring to FIG. 6, a structural diagram of another embodiment of the present invention. As shown, in the previous embodiments, the identifying chip and antenna of the identifying module are all mainly discussed in the anti-counterfeiting apparatuses of the present invention, but according to the main inventive spirit of the present invention, the identifying module can also be replaced by general two dimensional barcodes or identifying barcodes 65 as long as the two dimensional barcodes or identifying barcodes 65 are fixed on a proper position where needed to be destructed when opening and using the product, such as seal 511, and the structure of the two dimensional barcodes or identifying barcodes 65 will be destructed when opening and using the products. The object of the present invention can also be achieved.

In summary, it is appreciated that the present invention relates to an anti-counterfeiting apparatus, and more particularly to an anti-counterfeiting apparatus capable of remote identifying. It not only can distinguish the real or counterfeited products but also has an effect of quickly identifying products and easily managing.

The foregoing description is merely one embodiment of present invention and not considered as restrictive. All equivalent variations and modifications in process, method, feature, and spirit in accordance with the appended claims may be made without in any way from the scope of the invention.

LIST OF REFERENCE SYMBOLS

| | |
|---|---|
| 10 | product |
| 105 | package |
| 11 | wireless label |
| 111 | chip |
| 115 | antenna |
| 21 | product |
| 215 | package |
| 23 | membrane |
| 231 | destructive structure |
| 235 | crack |
| 25 | identifying module |
| 251 | identifying chip |
| 253 | antenna |
| 31 | package |
| 33 | screw-top |
| 331 | broken groove |
| 333 | anti-counterfeiting ring |
| 335 | rotating force |
| 35 | identifying module |
| 351 | identifying chip |
| 353 | antenna |
| 41 | package |
| 43 | cap |
| 45 | identifying module |
| 451 | identifying chip |
| 453 | antenna |
| 51 | soft package |
| 511 | seal |
| 513 | opening |
| 531 | destructive groove |
| 55 | identifying module |
| 551 | identifying chip |
| 553 | antenna |
| 65 | identifying module |

1. An anti-counterfeiting apparatus capable of remote identifying, comprising:
a membrane, an identifying module set therein, and capable of being fixed on a product; and
a destructive structure fixed on part of a surface of said membrane for naturally destructing said identifying module when said destructive structure is open.

2. The anti-counterfeiting apparatus according to claim 1, wherein said identifying module is formed by electrically connecting at least one antennas and an identifying chip.

3. The anti-counterfeiting apparatus according to claim 1, wherein said membrane can selectively cover one of a seal, surface, package, outer package, outer packing box, and a combination thereof.

4. The anti-counterfeiting apparatus according to claim 1, wherein said destructive structure is a destructive groove.

5. The anti-counterfeiting apparatus according to claim 2, wherein said product further has a screw-top comprising a broken groove and an anti-counterfeiting ring, on said broken groove and said anti-counterfeiting ring fixed one of said antennas and said identifying chip, respectively.

6. The anti-counterfeiting apparatus according to claim 1, wherein said product further has a cap, and said identifying module directly fixed on said cap.

7. The anti-counterfeiting apparatus according to claim 6, wherein said cap can be made by a material selected from one of a cork, plastic, and a combination thereof.

8. The anti-counterfeiting apparatus according to claim 1, wherein said identifying module can be selected from an identifying barcode and a two-dimensional barcode.

9. The anti-counterfeiting apparatus according to claim 1, wherein said product can be a flexible package, said flexible package is fixed a seal, and said identifying module can be fixed on said seal.
